(19) United States
(12) Patent Application Publication
(10) Pub. No.: US 2008/0260968 A1
(43) Pub. Date: Oct. 23, 2008

(54) METHOD OF FORMING AMORPHOUS CARBON LAYER USING CROSS TYPE HYDROCARBON COMPOUND AND METHOD OF FORMING LOW-K DIELECTRIC LAYER USING THE SAME

(75) Inventors: Kyung Soo KIM, Seoul (KR); Geun Hag BAE, Kyungki-do (KR); Ho Sik KIM, Kyungki-do (KR)

Correspondence Address: CANTOR COLBURN, LLP, 20 Church Street, 22nd Floor, Hartford, CT, 06103, US

(73) Assignee: ATTO CO., LTD., Kyungki-do (KR)

(21) Appl. No.: 11/865,965

(22) Filed: Oct. 2, 2007

(30) Foreign Application Priority Data
Apr. 23, 2007 (KR) 10-2007-0039469
Jun. 4, 2007 (KR) 10-2007-0054194

(51) Int. Cl. H05H 1/24

(52) U.S. Cl. 427/577; 427/249.1; 427/249.15

(57) ABSTRACT

A method of forming an amorphous carbon layer using a cross type hydrocarbon compound as a precursor and a method of forming a low-k dielectric layer using the same are disclosed. The present invention includes a step (a) of vaporizing a precursor containing a cross type hydrocarbon compound, a step (b) of supplying the vaporized precursor and a additive gas into a reaction chamber via a shower head, wherein the precursor and the additive gas are changed into plasma state, and a step (c) of depositing the amorphous carbon layer for the hard mask or the low-k dielectric in the reaction chamber.

This application claims priority to Korean Patent Application Nos. 10-2007-0039469 and 10-2007-0054194, filed on Apr. 23, 2007 and Jun. 4, 2007, respectively, all the benefits accruing therefrom under 35 U.S.C. §119, the contents of which in their entirety are incorporated herein by reference.

### BACKGROUND OF THE INVENTION

1. Field of the Invention

The present invention relates to a method of forming an amorphous carbon layer and a method of forming a low-k dielectric layer, and more particularly, to a method of forming an amorphous carbon layer using a cross type hydrocarbon compound as a precursor and a method of forming a low-k dielectric layer using the same.

2. Discussion of the Related Art

Generally, an amorphous carbon layer is deposited using a gas mixture containing a hydrocarbon compound and such inert gas as Ar and He by plasma or thermal activation. The deposited amorphous carbon layer is applied to various fields for a bionic material, organic light emitting diode (OLED), semiconductor integrated circuit, hard mask, and the like.

Amorphous carbon layer deposition, which is applied to hardmask, ARC (anti-reflective coating), DARC (dielectric anti-reflective coating), BARC (bottom anti-reflective coating) and the like, according to a related art is disclosed in U.S. Patent Laid Open No. US 2006-0084280 (Apr. 20, 2006) or U.S. Pat. No. 7,079,740 (Jul. 18, 2006), in which a linear type hydrocarbon compound or a cyclic type hydrocarbon compound is mainly used as a precursor.

Alkane series (CₙH₂ₙ₊₂), alkene series (CₙH₂ₙ) or alkyne (CₙH₂ₙ₋₂) series are representative for the linear type hydrocarbon compound. And, benzene series or cyclohexane series are representative for the cyclic type hydrocarbon compound. FIG. 1 shows butane (C₄H₁₀) and propylene (C₃H₆) as representative examples of the linear type hydrocarbon compounds. FIG. 2 shows benzene (C₆H₆) and tri-methylbenzene (C₉H₁₂) as representative examples of the cyclic type hydrocarbon compounds.

An amorphous carbon layer deposited by PECVD or the like has complex formations of a linear, branch or cyclic type structures and a bond structure including a single, double or triple bonds. A ratio of the complex formations varies according to a precursor structure as well as properties thereof. In particular, in case of using a linear type hydrocarbon compound as a precursor, a structure of a deposited amorphous carbon layer mainly becomes a linear or branch type. In case of using a cyclic type hydrocarbon compound as a precursor, a deposited amorphous carbon layer mainly has a configuration that a cyclic type is connected between a linear type and a branch type.

The precursor used for deposition in a liquid or gaseous phase is supplied to a reaction chamber. If the precursor in the gaseous phase is supplied to the reaction chamber, ionization energy is high. So, a deposited layer has high hydrogen content. Particles are generated from the process. Hardness of the layer may be raised. Yet, a deposition rate is very low. In case that the precursor in the liquid phase is supplied to the reaction chamber, a deposition rate is high. Yet, it is disadvantageous that hardness of the deposited layer is lowered.

### SUMMARY OF THE INVENTION

Accordingly, the present invention is directed to a method of forming an amorphous carbon layer using a cross type hydrocarbon compound as a precursor and a method of forming a low-k dielectric layer using the same that substantially obviate one or more problems due to limitations and disadvantages of the related art.

An object of the present invention is to provide a method of depositing an amorphous carbon layer, by which the amorphous carbon layer for a hard mask or low-k dielectric can be deposited using a cross type hydrocarbon compound or a hydrocarbon compound having a structure similar to that of the former compound as a precursor to deposit the amorphous carbon layer.

Another object of the present invention is to provide a method of depositing an amorphous carbon layer using a gas-separation type shower head, by which a cross type hydrocarbon compound or a hydrocarbon compound having a structure similar to that of the former compound is used as a precursor to deposit the amorphous carbon layer.

A further object of the present invention is to provide a method of forming a low-k dielectric layer, by which a cross type hydrocarbon compound is used as a precursor to form the low-k dielectric layer as well as a generally used material containing Si—O.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of forming an amorphous carbon layer using a cross type hydrocarbon compound according to the present invention includes a step (a) of vaporizing a precursor containing the cross type hydrocarbon compound, a step (b) of supplying the vaporized precursor and a additive gas into a reaction chamber via a shower head, wherein the precursor and the additive gas are changed into plasma state; and a step (c) of depositing the amorphous carbon layer for a hard mask or a low-k dielectric in the reaction chamber.

In another aspect of the present invention, a method of forming a low-k dielectric layer using a cross type hydrocarbon compound according to the present invention includes a step (a) of vaporizing a precursor comprising a first precursor containing Si—O and a second precursor containing the cross type hydrocarbon compound, a step (b) of supplying the vaporized precursor and a additive gas into a reaction chamber via a shower head, wherein the precursor and the additive gas are changed into plasma state; and a step (c) of depositing the low-k dielectric layer in the reaction chamber.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary diagram of precursors used for a method of forming an amorphous carbon layer according to a related art;

FIG. 2 is another exemplary diagram of precursors used for a method of forming an amorphous carbon layer according to a related art;

FIG. 3 is a flowchart of a method of forming an amorphous carbon layer according to one embodiment of the present invention;

FIG. 4 is a block diagram of a depositing device used for a method of forming an amorphous carbon layer according to one embodiment of the present invention;

FIG. 5 is an exemplary diagram of hydrocarbon compounds used for a method of forming an amorphous carbon layer according to one embodiment of the present invention;

FIG. 6 is a diagram of a shower head used for a method of forming an amorphous carbon layer according to one embodiment of the present invention;

FIG. 7 is a detailed diagram of a scattering part and an injecting part in the shower head shown in FIG. 6;

FIG. 8 is a flowchart of a method of forming a low-k dielectric layer according to one embodiment of the present invention; and

FIG. 9 is a schematic diagram of a configuration of DMCPSO.

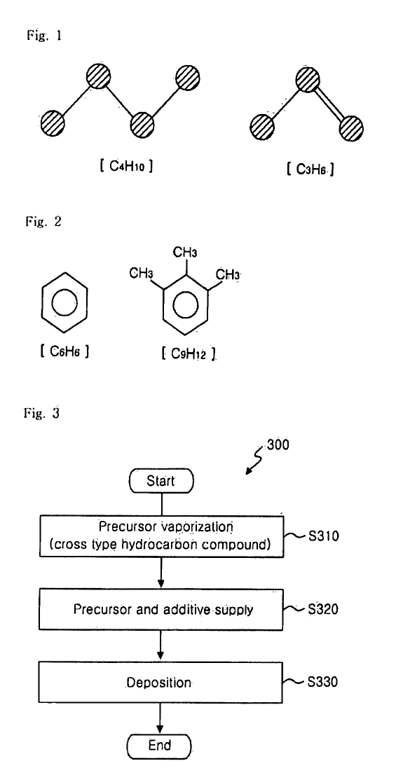

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

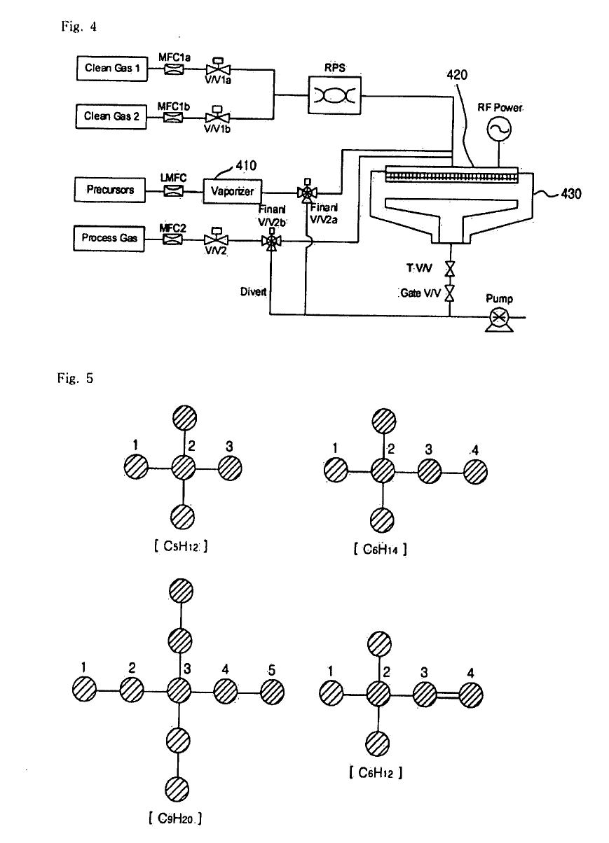

FIG. 3 is a flowchart of a method of forming an amorphous carbon layer according to one embodiment of the present invention. FIG. 4 is a block diagram of a depositing device used for the amorphous carbon layer forming method 300 shown in FIG. 3. In describing the amorphous carbon layer forming method 300 shown in FIG. 3, an amorphous carbon layer depositing device 400 shown in FIG. 4 is referred to.

Referring to FIG. 3, an amorphous carbon layer forming method 300 includes a precursor vaporizing step S310, a precursor and additive gas supplying step S320, and a depositing step S330.

In the precursor vaporizing step S310, such a vaporizing device 410 as a vaporizer, a bubbler and the like is used to vaporize a precursor containing a hydrocarbon compound in a liquid phase. In case of using the bubbler, the precursor can be bubbled together with such gas as Ar, H₂, O₂, N₂, He, and the like.

FIG. 5 is an exemplary diagram of hydrocarbon compounds used for a method of forming an amorphous carbon layer according to one embodiment of the present invention.

Referring to FIG. 5, each hydrocarbon compound is a cross type hydrocarbon compound configured in a manner that a pair of functional groups are bonded to a prescribed carbon atom except first and N^{th} carbon atoms in the linear structure including N (natural number equal to or greater than 3) carbon atoms bonded singly, doubly, and/or triply. In this case, the functional groups representatively include methyl (—CH₃), ethyl (—C₂H₅), benzyl (—CH₂—C₆H₅), phenyl (—C₆H₅), etc. Optionally, each of the functional groups can include at least one selected from the group consisting of nitrogen, oxygen, fluorine, and chlorine such as —CₓF_{y}, —NH₂, —NO, —OH, —CHO, —COOH, etc.

For example, the cross type hydrocarbon compounds include 2,2-dimethylpropane, 2,2-dimethyl-propene, 2,2-dimethylbutane, 3,3-dimethyl-1-butene, 3,3-dimethyl-1,3-butadiene, 3,3-dimethylpentane, 3,3-dimethyl-1-pentene, 3,3-dimethyl-1,4-pentadiene, 3,3-diethylpentane, 3,3-diethyl-1-pentene, 3,3-diethyl-1,4-pentadiene, 3,3-dimethylhexane, 3,3-dimethyl-1-hexene, 3,3-dimethyl-1,4-hexadiene, 3,3-dimethyl-1,5-hexadiene, 3,3-diethylhexane, 3,3-diethyl-1-hexene, 3,3-diethyl-1,4-hexadiene, 3,3-diethyl-1,5-hexadiene), etc. At least one of the above compounds is usable as a precursor. Alternatively, one of the above compounds and another hydrocarbon compound are usable as the precursor.

Instead of using the cross type hydrocarbon compound configured in a manner that two functional groups are bonded to a prescribed carbon atom in a linear chain, a hydrocarbon compound, which is configured in a manner that one functional group is bonded to a prescribed carbon atom except first and M^{th} carbon atoms in the linearly bonded carbon structure having M (natural number equal to or greater than 4) carbon atoms and that the other functional group is bonded to another carbon thereof, is usable. For example, this hydrocarbon compound includes one of 2,3-dimethylbutane, 2,3-dimethyl-1-butene, 2,3-dimethyl-1,3-butadiene, and the like. Besides, for another example of the hydrocarbon compound, functional groups can be located at different positions of one basic skeletal structure of the above enumerated materials.

Specifically, compared to a linear or cyclic type hydrocarbon compound, the cross type hydrocarbon compound has relatively low ionization energy. So, it is able to increase a deposition rate of an amorphous carbon layer with a low power. Owing to features of the cross type configuration, polymerization of a linear structure is facilitated in a plasma state as well as deposition of a cyclic type amorphous carbon layer is enabled. Thus, both linear and cyclic type precursor properties are simultaneously provided to form various amorphous carbon layers differing in structure. And, the cross type hydrocarbon compound is able to compensate for disadvantages of a gaseous precursor having a low deposition rate. Moreover, the cross type hydrocarbon compound is facilitated to compensate for a disadvantage of a liquid precursor having low hardness.

In the precursor and additive gas supplying step S320, the precursor vaporized in the vaporizing step S310 is supplied into a reaction chamber 430 via a shower head 420 together with additive gas. In this case, the additive gas includes at least one selected from the group consisting of He, Ar, H₂, O₂, N₂, N₂O, NO, hydrocarbon compound CₓH_{y} (where 1≦x≦9, 4≦y≦20). And, the additive gas includes one selected from the group consisting of a material containing nitrogen such as NH₃, a material containing fluorine such as CF₄, and a material containing silicon such as SiH₄. If so, such a carbon layer containing N, F or Si as α-CN, α-CF, and α-SiCH can be deposited.

The vaporized precursor and the additive gas, as shown in FIG. 4, are mixed together and then supplied to the shower head 420. In the precursor and additive gas supplying step S320, even if a power for plasma is applied to the shower head 420, the precursor can enter a plasma state at least. In this case, the power for plasma may be set to 10 W˜1.5 kW to be applied to the shower head 420. And, RF (radio frequency) power, DC (direct current) power or microwave power is used as the power for the plasma and then applied to the shower head 420.

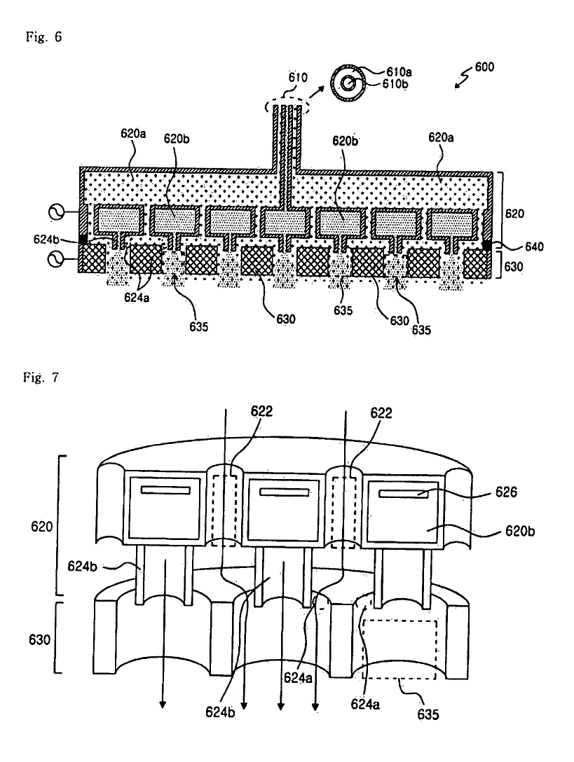

Instead of being mixed together in advance, the vaporized precursor and the additive gas can be mixed together in the shower head 420, and more particularly, right before being injected into the reaction chamber 430. FIG. 6 shows an example of the shower head and FIG. 7 is a detailed diagram of a scattering part 620 and an injecting part 630 in the shower head 600 shown in FIG. 6.

A shower head 600, as shown in FIG. 6, includes a supplying part 610 for separately supplying a precursor and an additive gas from a pair of supplying pipes 610a and 610b, a scattering part 620 separately scattering the separately supplied precursor and the separately supplied additive gas, and an injecting part 630 having a plurality of holes 635 to inject commonly the precursor and the additive gas separately scattered by the scattering part 620 via a plurality of the holes 635.

The scattering part 620 includes a first scattering region 620a placed under the supplying part 610 to have a single area, a second scattering region 620b placed under the first scattering region 620a to be divided into a plurality of areas with paths 622 between a plurality of the areas, and a plurality of vents 624b attached to each of a plurality of the areas of the second scattering region 620b. A gas distributing plate 626 can be provided to each of the divided areas of the second scattering region 620b to evenly distribute the gas. In this case, one of the precursor and the additive gas is scattered by the first scattering region 620a and then vented to a plurality of spaces 624a enclosing each of the vents 624b via the paths 622 between a plurality of the areas of the second scattering region 620b. The other is scattered by the second scattering region 620b and then vented to each of the vents 624b.

When the power for plasma is applied to the scattering part 620 or the injecting part 630, the precursor enters a plasma state at least. So, the plasma precursor can be injected into the reaction chamber 430.

An insulator ring 640 can be further included to electrically insulating the scattering part 620 and the injecting part 630 from each other. Alternatively, an insulator material capable of electrical insulation can be coated on the scattering part 620 or the injecting part 630. In this case, the insulator can include one of a ceramic substance such as Al₂O₃, AlN and the like, a polymer substance such as Teflon and the like, and a composite of the ceramic and polymer substances.

The power for plasma can be simultaneously applied to both of the scattering part 620 and the injecting part 630. In particular, different plasma powers can be applied to the scattering part 620 and the injecting part 630, respectively.

In the depositing step S330, deposition of an amorphous carbon layer is carried out within the reaction chamber 430 using the supplied precursor and additive gas in plasma state. In this case, to raise deposition efficiency, the power for plasma keeps being applied to the shower head 420 or a constant power is applied to an inside of the reaction chamber 430.

In the depositing step S330, the internal environment of the reaction chamber 430 can be maintained at 25° C.˜500° C. with 0.1 Torr˜10 Torr. The depositing step S330 can be carried out at a deposition rate of 5˜500 nm/min. In general, if a deposition rate is high on same condition, deposition of large molecules is mainly accomplished to lower layer density. If the deposition rate is low, the layer density is raised. Thus, the deposition rate can be properly adjusted according to a process target.

A ratio of the precursor supplied into the reaction chamber 430 for the deposition of the amorphous carbon layer can be set to 5˜100% of the overall precursor and additive gas.

Amorphous Layer for Hard Mask

A structure of an amorphous carbon layer can be diversified into PLC (polymer-like-carbon), GLC (graphite-like-carbon), DLC (diamon-like-carbon) and the like according to a configuration of a precursor.

In case that an amorphous carbon layer is to be applied to a hard mask for semiconductor device fabrication, hardness of the formed amorphous carbon layer should be high. For this, the formed amorphous carbon layer preferably has the DLC structure.

To form the DLC type amorphous carbon layer from a precursor, a number of methyl groups (—CH₃), each of which includes a carbon atom (c) and three hydrogen atoms (H) bonded to the carbon atom, are needed. Preferably, at least one of two functional groups of a cross type hydrocarbon compound or another hydrocarbon compound similar to the cross type hydrocarbon compound is the methyl group (—CH₃).

An amorphous carbon layer deposited by the method shown in FIG. 3 can have one of various structures of PLC, GLC, DLC and the like. And, the amorphous carbon layer can have a wide range of Young's Modulus between 0.1˜90 GPa.

According to experiment, when an amorphous carbon layer for hard mask is deposited, 500˜1,500 nm thick using 3.3-dimethyl-1-butene of a precursor gas as a precursor by the amorphous carbon layer forming method using the cross type hydrocarbon compound according to the present invention, a refractive index of 1.0˜2.0 and an extinction coefficient of 0.1˜0.3, which is considerably lower than that of the related art amorphous carbon layer, appear at a wavelength of 248 nm.

Amorphous Carbon Layer for Low-k Dielectric

An amorphous carbon layer for low-k dielectric finally includes a plurality of chain structures or cross-linking structures through active species from a precursor. In this case, nano-pores are generated in the cross-linking structure of the final amorphous carbon layer. If many nano-pores are formed, more empty spaces are, provided within the amorphous carbon layer. So, it is able to lower a dielectric constant value of the amorphous carbon layer. Hence, in a step of an amorphous carbon layer for low-k dielectric, it is preferable that more cross-linking structures are formed.

According to experiments, a case of adding He as an additive gas has a dielectric constant value greater than that of a case of adding Ar. If a pressure decreases with the same power, a dielectric constant value increases. A low-k dielectric amorphous carbon layer deposited by an amorphous carbon layer forming method using a cross type hydrocarbon compound according to the present invention has a dielectric constant value between 2.0˜3.2, thereby being usable as low-k dielectric. This is attributed to a number of the cross-linking structures of the amorphous carbon layer and the dielectric constant reduced by a number of the nano-pores.

It is disadvantageous that the related art amorphous carbon layer for low-k dielectric has low hardness. Yet, the amorphous carbon layer for low-k dielectric formed by the amorphous carbon layer forming method using the cross type hydrocarbon compound according to the present invention is able to increase layer hardness using a cross type hydrocarbon compound or a hydrocarbon compound having a structure similar to that of the cross type hydrocarbon compound as a precursor.

Low-k Dielectric Layer

FIG. 8 is a flowchart of a method of forming a low-k dielectric layer according to one embodiment of the present invention. A low-k dielectric layer forming method 800 shown in FIG. 8 can employ the amorphous carbon layer forming device 400 shown in FIG. 4 as it is.

Referring to FIG. 8, a low-k dielectric layer forming method 800 includes a precursor vaporizing step S810, a precursor and additive gas supplying step S820, and a depositing step S830.

In the precursor vaporizing step S810, such a vaporizing device 410 as a vaporizer, a bubbler and the like is used to vaporize a precursor in a liquid phase. The precursor includes a first precursor containing generally used Si—O and a second precursor containing a cross type hydrocarbon compound. In case of using the bubbler, the precursor can be bubbled together with such gas as Ar, H₂, O₂, N₂, He, and the like. The precursor can be vaporized in a manner of mixing the first and second precursors together in advance (cf. FIG. 4). Alternatively, the precursor can be used in a manner of vaporizing the first precursor and the second precursor separately and then mixing the vaporized first and second precursors together (not shown).

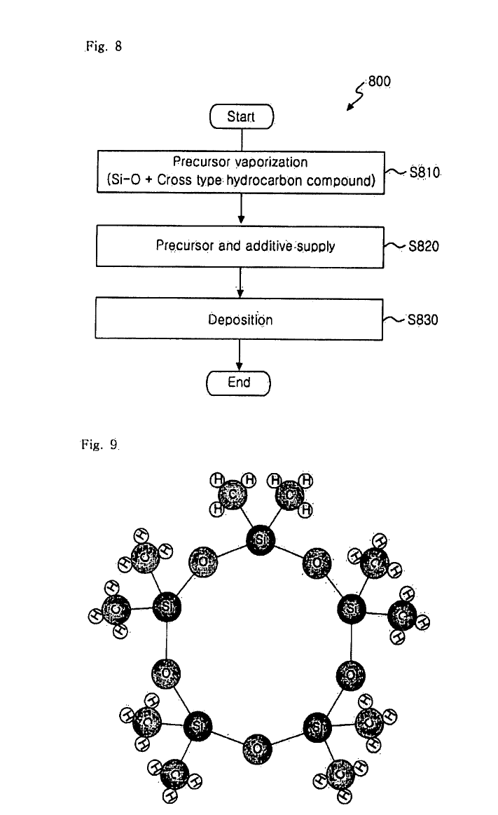

The first precursor includes at least one of DMCPSO (deca-methylcyclopentasiloxane), TEOS (tetra-ethyl-ortho-siloxane), HMDSO (hexa-methyl-disiloxane), and the like. FIG. 9 is a schematic diagram of a configuration of DMCPSO.

In the precursor and additive gas supplying step S820, the precursor vaporized in the vaporizing step S810 is supplied into a reaction chamber 430 via a shower head 420 together with additive gas.

In this case, the additive gas includes at least one selected from the group consisting of He, Ar, H₂, O₂, N₂, N₂O, NO, hydrocarbon compound CₓH_{y} (where 1≦x9, 4≦y≦20). And, the additive gas includes one selected from the group consisting of a material containing nitrogen such as NH₃, a material containing fluorine such as CF₄, and a material containing silicon such as SiH₄.

The vaporized precursor and the additive gas, as shown in FIG. 4, are mixed together and then supplied to the shower head 420. In the precursor and additive gas supplying step S820, even if a power for generating plasma is applied to the shower head 420, the precursor can enter a plasma state at least. In this case, the power for generating plasma may be set to 10 W˜1.5 kW to be applied to the shower head 420. And, RF (radio frequency) power, DC (direct current) power or microwave power is used as the power for generating plasma and then applied to the shower head 420.

Instead of being mixed together in advance, the vaporized precursor and the additive gas can be mixed together right before being injected into the reaction chamber 430. For this, the gas separate type shower head 600 shown in FIG. 6 or FIG. 7 is usable.

In the depositing step S830, deposition of a low-k dielectric is carried out within the reaction chamber 430 using the supplied precursor and additive gas in plasma state. In this case, to raise deposition efficiency, the power for generating plasma keeps being applied to the shower head 420 or a constant power is applied to an inside of the reaction chamber 430.

In the depositing step S830, the internal environment of the reaction chamber 430 can be maintained at 25° C.˜500° C. with 0.1 Torr˜10 Torr. The depositing step S830 can be carried out at a deposition rate of 5˜500 nm/min.

In general, if a deposition rate is high on same condition, deposition of large molecules is mainly accomplished to lower layer density. If the deposition rate is low, the layer density is raised. Thus, the deposition rate can be properly adjusted according to a process target.

In a ratio of the precursor supplied into the reaction chamber 430 for the deposition of the low-k dielectric layer, a ratio of the first precursor such as DMCPSO and the like among the precursor supplied into the reaction chamber 430 can be set to 5˜99% of the overall precursor and additive gas.

Accordingly, the present invention has a cross type hydrocarbon compound included in a precursor, thereby forming a low-k dielectric layer having a considerably low dielectric constant k. And, the present invention enhances hardness and modulus of the low-k dielectric layer.

In a method of forming an amorphous carbon layer using a cross type hydrocarbon compound according to the present invention, layer hardness can be raised using a cross type hydrocarbon compound or a hydrocarbon compound configured similar to the cross type hydrocarbon compound having a number of methyl functional groups (—CH₃). Hence, the formed amorphous carbon layer is applicable to a hard mask.

In a method of forming an amorphous carbon layer using a cross type hydrocarbon compound according to the present invention, nano-pore formation is facilitated using a cross type hydrocarbon compound or a hydrocarbon compound configured similar to the cross type hydrocarbon compound. Hence, the formed amorphous carbon layer is applicable to a low-k dielectric.

In a method of forming a low-k dielectric layer using a cross type hydrocarbon compound, a deposition rate is increased using a cross type hydrocarbon compound as well as a material containing normally used Si—O. And, a low-k dielectric layer having a considerably low dielectric constant (k) and improved hardness and modulus can be obtained as well.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of forming an amorphous carbon layer for a hard mask, comprising:
a step (a) of vaporizing a precursor containing a hydrocarbon compound configured in a manner that a pair of functional groups are bonded to a prescribed carbon atom except first and N^{th} carbon atoms in a structure including N (natural number equal to or greater than 3) carbon atoms linearly bonded together wherein at least one of the functional groups includes a methyl group (—CH₃);
a step (b) of supplying the vaporized precursor and an additive gas of He or Ar into a reaction chamber via a shower head, wherein the precursor and the additive gas are changed into plasma state; and
a step (c) of depositing the amorphous carbon layer for the hard mask in the reaction chamber.

2. A method of forming an amorphous carbon layer for a hard mask, comprising:
a step (a) of vaporizing a precursor containing a hydrocarbon compound configured in a manner that a pair of functional groups are bonded to a pair of carbon atoms except first and M^{th} carbon atoms in a structure including M (natural number equal to or greater than 4) carbon atoms linearly bonded together wherein at least one of the functional groups includes a methyl group (—CH₃);
a step (b) of supplying the vaporized precursor and an additive gas of He or Ar into a reaction chamber via a shower head, wherein the precursor and the additive gas are changed into plasma state; and
a step (c) of depositing the amorphous carbon layer for the hard mask in the reaction chamber.

3. A method of forming an amorphous carbon layer for a low-k dielectric, comprising:
a step (a) of vaporizing a precursor containing a hydrocarbon compound configured in a manner that a pair of functional groups are bonded to a prescribed carbon atom except first and N^{th} carbon atoms in a structure including N (natural number equal to or greater than 3) carbon atoms linearly bonded together wherein at least one of the functional groups includes a methyl group (—CH₃);
a step (b) of supplying the vaporized precursor and an additive gas of He or Ar into a reaction chamber via a shower head, wherein the precursor and the additive gas are changed into plasma state; and
a step (c) of depositing the amorphous carbon layer for the low-k dielectric including a cross-linking structure in the reaction chamber.

4. A method of forming an amorphous carbon layer for a low-k dielectric, comprising:
a step (a) of vaporizing a precursor containing a hydrocarbon compound configured in a manner that a pair of functional groups are bonded to a pair of carbon atoms except first and M^{th} carbon atoms in a structure including M (natural number equal to or greater than 4) carbon atoms linearly bonded together wherein at least one of the functional groups includes a methyl group (—CH₃);
a step (b) of supplying the vaporized precursor and an additive gas of He or Ar into a reaction chamber via a shower head, wherein the precursor and the additive gas are changed into plasma state; and
a step (c) of depositing the amorphous carbon layer for the low-k dielectric including a cross-linking structure in the reaction chamber.

5. A method of forming an amorphous carbon layer, comprising:
a step (a) of vaporizing a precursor containing a hydrocarbon compound configured in a manner that a pair of functional groups are bonded to a prescribed carbon atom except first and N^{th} carbon atoms in a structure including N (natural number equal to or greater than 3) carbon atoms linearly bonded together;
a step (b) of supplying the vaporized precursor and a additive gas into a reaction chamber via a shower head, the shower head comprising a supplying part for separately supplying the precursor and the additive gas, a scattering part separately scattering the separately supplied precursor and the separately supplied additive gas, and an injecting part having a plurality of holes to inject commonly the precursor and the additive gas separately scattered by the scattering part via the holes, wherein a power for generating plasma is applied to at least one of the scattering part and the injecting part; and
a step (c) of depositing the amorphous carbon layer in the reaction chamber.

6. The method of claim 5, wherein the additive gas comprises at least one selected from the group consisting of He, Ar, H₂, O₂, N₂, N₂O, NO, hydrocarbon compound CₓH_{y} (where 1≦x≦9, 4≦y≦20), a nitrogen-contained substance, a fluorine-contained substance, and a silicon-contained substance.

7. The method of claim 5, wherein each of the functional groups comprises at least one selected from the group consisting of —CH₃, —C₂H₅, —CH₂—C₆H₅, —C₆H₅, —CₓF_{y}, —NH₂, —NO, —OH, —CHO, and —COOH.

8. The method of claim 5, wherein the shower head further comprises an insulator ring electrically insulating the scattering part and the injecting part from each other or wherein an insulator material capable of electrical insulation is coated on at least one of the scattering part and the injecting part.

9. The method of claim 8, wherein if the power for generating the plasma is applied to the scattering part and the injecting part in the step (b), it is differently applied to the scattering part and the injecting part.

10. The method of claim 5, the scattering part comprising:
a first scattering region placed under the supplying part to have a single area;
a second scattering region placed under the first scattering region to be divided into a plurality of areas with paths between a plurality of the areas; and
a plurality of vents attached to each of a plurality of the areas of the second scattering region,
wherein one of the precursor and the additive gas is scattered by the first scattering region and then vented to a plurality of spaces enclosing each of the vents via the paths between a plurality of the areas of the second scattering region and wherein the other is scattered by the second scattering region and then vented to each of the vents.

11. A method of forming an amorphous carbon layer, comprising:
a step (a) of vaporizing a precursor containing a hydrocarbon compound configured in a manner that a pair of functional groups are bonded to a pair of carbon atoms except first and M^{th} carbon atoms in a structure including M (natural number equal to or greater than 4) carbon atoms linearly bonded together;
a step (b) of supplying the vaporized precursor and a additive gas into a reaction chamber via a shower head, the shower head comprising a supplying part for separately supplying the precursor and the additive gas, a scattering part separately scattering the separately supplied precursor and the separately supplied additive gas, and an injecting part having a plurality of holes to inject commonly the precursor and the additive gas separately scattered by the scattering part via the holes, wherein a power for generating plasma is applied to at least one of the scattering part and the injecting part; and
a step (c) of depositing the amorphous carbon layer in the reaction chamber.

12. A method of forming a low-k dielectric layer, comprising:
a step (a) of vaporizing a precursor comprising a first precursor containing Si—O and a second precursor containing a hydrocarbon compound configured in a manner that a pair of functional groups are bonded to a prescribed carbon atom except first and N^{th} carbon atoms in a structure including N (natural number equal to or greater than 3) carbon atoms linearly bonded together;
a step (b) of supplying the vaporized precursor and the additive gas into a reaction chamber via a shower head, wherein the precursor and the additive gas are changed into plasma state; and
a step (c) of depositing the low-k dielectric layer in the reaction chamber.

13. The method of claim 12, wherein the first precursor comprises at least one selected from the group consisting of DMCPSO (deca-methylcyclopentasiloxane), TEOS (tetra-ethyl-ortho-siloxane), and HMDSO (hexa-methyl-disiloxane).

14. The method of claim 12, wherein the additive gas comprises at least one selected from the group consisting of He, Ar, H₂, O₂, N₂, N₂O, NO, hydrocarbon compound CₓH_{y} (where 1≦x≦9, 4≦y≦20), a nitrogen-contained substance, a fluorine-contained substance, and a silicon-contained substance.

15. The method of claim 12, wherein each of the functional groups comprises at least one selected from the group consisting of —CH₃, —C₂H₅, —CH₂—C₆H₅, —C₆H₅, —CₓF_{y}, —NH₂, —NO, —OH, —CHO, and —COOH.

16. The method of claim 12, the shower head comprising:
a supplying part for separately supplying the precursor and the additive gas;
a scattering part separately scattering the separately supplied precursor and the separately supplied additive gas; and
an injecting part having a plurality of holes to inject commonly the precursor and the additive gas separately scattered by the scattering part via the holes,
wherein in the step (b), a power for generating plasma is applied to at least one of the scattering part and the injecting part.

17. The method of claim 16, wherein the shower head further comprises an insulator ring electrically insulating the scattering part and the injecting part from each other or wherein an insulator material capable of electrical insulation is coated on at least one of the scattering part and the injecting part.

18. The method of claim 17, wherein in the step (b), if the power for generating the plasma is applied to the scattering part and the injecting part, it is differently applied to the scattering part and the injecting part.

19. The method of claim 16, the scattering part comprising:
a first scattering region placed under the supplying part to have a single area;
a second scattering region placed under the first scattering region to be divided into a plurality of areas with paths between a plurality of the areas; and
a plurality of vents attached to each of a plurality of the areas of the second scattering region,
wherein one of the precursor and the additive gas is scattered by the first scattering region and then vented to a plurality of spaces enclosing each of the vents via the paths between a plurality of the areas of the second scattering region and wherein the other is scattered by the second scattering region and then vented to each of the vents.
